(19) United States
(12) Patent Application Publication
(10) Pub. No.: US 2008/0055246 A1
(43) Pub. Date: Mar. 6, 2008

(54) Projector, terminal, and image communication system

(75) Inventors: Hideaki Okayama, Tokyo (JP); Takeshi Kamijoh, Tokyo (JP)

Correspondence Address: RABIN & Berdo, PC, 1101 14TH STREET, NW, SUITE 500, WASHINGTON, DC, 20005, US

(73) Assignee: OKI ELECTRIC INDUSTRY CO., LTD., Tokyo (JP)

(21) Appl. No.: 11/812,428

(22) Filed: Jun. 19, 2007

(30) Foreign Application Priority Data
Sep. 6, 2006 (JP) JP2006-241873

(51) Int. Cl. G09G 5/00

(52) U.S. Cl. 345/158

(57) ABSTRACT

A projector projects an image onto an image projection area by scanning the image projection area with a light beam including both image signal light and communication signal light. The image signal light and communication signal light may have different wavelengths, or the communication signal may be modulated onto one or more of the wavelengths of the image signal light. A terminal receives the communication signal light from the image projection area, processes the communication signal, and when necessary, transmits an answering signal to the projector. An audience equipped with such terminals can interact with the projected image at a high data communication rate without impairing the visibility of the image.

### BACKGROUND OF THE INVENTION

1. Field of the Invention

The present invention relates to a projector that projects a visible image including an invisible communication signal light, a terminal that receives the communication signal light from the projected image, and an image communication system including the projector and at least one such terminal.

2. Description of the Related Art

It is a known art to control an image transmitting device such as a personal computer by manipulating an image projected on a screen.

For example, Japanese Patent Application Publication (JP) No. 2004-128916 discloses a remote control terminal equipped with a laser pointer; the terminal memorizes the coordinates of a personal computer display projected on a screen, and communicates with the personal computer over a wireless link. The laser pointer functions as a so-called mouse, enabling the personal computer to be controlled on the screen. A disadvantage of this system is that the laser pointer can be used by only one person.

U.S. Pat. No. 4,371,893 discloses apparatus that projects an image on a touch-sensitive screen. The projected image can be modified by being touched with a pointer. A disadvantage of this apparatus is that the person wielding the pointer tends to block other people's view of the image.

JP 2000-174707 discloses a picture display device that combines a data communication function with a projection function. A disadvantage of this device is that it cannot project an image and conduct data communication simultaneously.

JP 2001-211372 discloses apparatus that projects an image, captures the projected image with a camera, and recognizes the captured image so that additional information about the image can be projected and thereby added to the image. A disadvantage of this system is that the time-consuming image recognition process makes high-speed communication impossible.

JP 2005-236667 discloses a communication system including a light-emitting diode (LED) display panel with LEDs for displaying an image and separate LEDs for data communication. A disadvantage of this system is that the entire panel cannot be used for image display.

There is an unanswered need for apparatus that can communicate bidirectionally with a large number of terminals via a display screen at a high communication rate, while simultaneously projecting an image onto the entire screen.

### SUMMARY OF THE INVENTION

An object of the present invention is to provide a projector that can communicate bidirectionally and at high speed with a large number of terminals via a projected visible image.

Another object of the invention is to provide a terminal that can communicate with such a projector.

Yet another object of the invention is to provide an image communication system incorporating the above projector and terminal.

The invention provides a projector for projecting an image on an image projection area such as a screen by linear scanning with a light beam. The projector includes an image signal generator for generating an image signal, a communication signal generator for generating a communication signal, at least one light emitting unit for generating a light beam including both image signal light modulated by the image signal and communication signal light modulated by the communication signal, and at least one scanning unit for scanning the light beam repeatedly across the image projection area to form a visible image.

The light beam is reflected from or transmitted through the image projection area. The reflected or transmitted communication signal light is received by a terminal that transmits answering information by means of a wireless signal such as an optical or radio signal. The projector has a projector receiver, possibly located behind the image projection area, that receives the answering information. The projector may also include a processor that executes processing according to the received answering information.

The facilities described above give the projector a bidirectional communication capability, and since the communication signal light projected by the projector is combined with the image signal light into the same beam, the entire image projection area can be used for display of the image.

The image signal generator may generate main and supplementary image signals, and each light emitting unit may include a modulator that modulates the main image signal by the communication signal. Each light emitting unit then includes supplementary and main optical signal generators that convert the supplementary and modulated main image signals to optical signals, which are combined to form the light beam.

This configuration enables the projector to display a full color image. For example, the main and supplementary optical signal generators may include LEDs that emit light of visible wavelengths corresponding to different primary colors, the total number of primary colors being at least three. All of the visible wavelengths are used for image display. The communication signal is modulated onto a subset of the visible wavelengths, typically onto just one of the visible wavelengths.

In an alternative configuration, each light emitter has an optical image signal generator that converts the image signal to image signal light in a given wavelength band and an optical communication signal generator that converts the communication signal to communication signal light of a wavelength external to this wavelength band. The image signal light and communication signal light are combined to form the light beam. Typically, the wavelength band of the image signal light is the visible band, the communication signal light is infrared light, and the optical communication signal generator includes an infrared LED. The optical communication signal generator may use a plurality of infrared LEDs emitting different wavelengths of infrared light to provide a plurality of communication channels.

With either projector configuration, the screen may be divided into multiple rectangular information sections, each including multiple beam scanning lines, and contiguous sets of these information sections may be grouped into image sections corresponding to objects or people in the projected image. The image sections may have different shapes and sizes, and their shapes or locations may change as the objects or people move about in the projected image. Within each image section, communication signal light carrying the same information is preferably projected onto each information section. The information may be information pertaining to the person or object displayed in the image section. This enables a terminal to obtain information about a displayed person or object by receiving communication signal light from any part of the image section corresponding to the person or object.

The invention also provides a terminal for receiving the communication signal light transmitted from the invented projector. The terminal has a telescopic optical system that enlarges an information section of the image projection area and a terminal receiver that receives communication signal light from that information section. A terminal processor processes the information included in the received communication signal light, and a transmitter transmits answering information to the projector when an answer is requested. The terminal may also have a display for displaying visual information, or a sound generator for producing audible information, as requested by the projector.

The invention also provides an image communication system including a projector and at least one terminal as described above. In this image communication system, the projector can communicate bidirectionally, at high speed, with an unrestricted number of terminals simultaneously while projecting an image onto the entire image projection area. When the image projection area is watched by an audience, these features enable the audience to interact with the projected image by controlling the image, obtaining additional information from the image, or providing feedback about the image, without impairing the visibility of the image.

### BRIEF DESCRIPTION OF THE DRAWINGS

In the attached drawings:

FIG. 1 is a schematic perspective drawing illustrating an image communication system according to a first embodiment of the invention;

FIG. 2 is a functional block diagram of the projector in the first embodiment;

FIG. 3 is a schematic perspective drawing of the light-emitting and scanning units in the first embodiment;

FIG. 4 is a schematic sectional view illustrating the projection optics in the first embodiment;

FIG. 5 is a graph schematically illustrating one of the optical image signals projected in the first embodiment;

FIG. 6 is a plan view schematically illustrating the division of the screen into image sections and information sections in the first embodiment;

FIG. 7 is an enlarged plan view of part the screen, schematically illustrating the scanning of a column of information sections in the first embodiment;

FIG. 8 is a functional block diagram of a terminal in the first embodiment;

FIGS. 9A and 9B are plan views of the screen, illustrating design conditions in the first embodiment;

FIG. 10 is a schematic perspective drawing illustrating an image communication system according to a variation of the first embodiment; and

FIG. 11 is a functional block diagram of the projector in a second embodiment of the invention.

### DETAILED DESCRIPTION OF THE INVENTION

Embodiments of the invention will now be described with reference to the attached drawings, in which like elements are indicated by like reference characters. The drawings are intended as an aid to understanding the embodiments, and do not show exact sizes, shapes, or positional relationships.

### First Embodiment

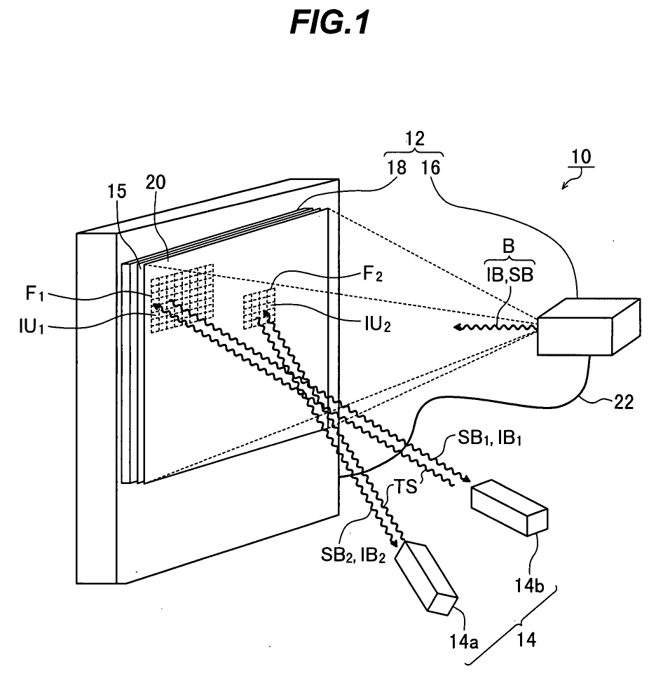

Referring to FIG. 1, the first embodiment is an image communication system 10 comprising a projector 12, a screen 20 functioning as the image projection area, and a plurality of terminals 14, shown in the drawing as a pair of terminals 14a, 14b.

The projector 12 includes a main projector unit 16 and a projector receiver 18. The main projector unit 16 is equipped with k light emitting units and k scanning units (described in detail later) that scan the screen 20 to form an image with k scanning lines, where k is an integer greater than unity. Each of the k scanning lines is scanned by a separate light beam B including both image signal light IB and communication signal light SB. For simplicity, only one of the k light beams B is indicated in FIG. 1.

The image signal light IB is an optical signal for projecting a visible image on the screen 20, whereas the communication signal light SB is an optical signal for transmitting information invisibly through the image to the terminals 14a, 14b. An image including invisible information is thereby projected on the screen 20.

The projector receiver 18 is a light receiving device disposed behind the screen 20, comprising a two-dimensional array of photosensor elements facing the entire area of the screen. The projector receiver 18 has the function of receiving answering optical signals TS transmitted from the terminals 14a, 14b.

The main projector unit 16 and the projector receiver 18 are interconnected by a cable 22. The answering optical signals TS received by the projector receiver 18 are converted to electrical signals and transmitted through the cable 22 to the main projector unit 16.

The screen 20 is a rectangular flat screen comprising a film that reflects the light beams B but transmits the answering optical signals TS. The image, including the communication signal light SB, is projected by scanning the light beams B vertically across the screen 20. A filter 15 that transmits only the answering optical signals TS from the terminals 14a, 14b is disposed between the screen 20 and the projector receiver 18.

In the example shown in FIG. 1, the image projected on the screen 20 includes two particular image sections F₁, F₂. Image section F₁ is divided into a plurality of smaller rectangular information sections IU₁. Similarly, image section F₂ is divided into a plurality of smaller rectangular information sections IU₂. Each information section receives a complete message in the communication signal light. All of the information sections IU₁, IU₂ have fixed locations and identical shapes and sizes. The image sections F₁, F₂ have arbitrary shapes, sizes, and locations, which may change over time, although each image section always consists of a whole number of information sections.

In a movie, for example, image sections F₁, F₂ may be the approximate areas occupied by images of two people projected on the screen 20. The image sections F₁, F₂ move and change in shape and size as the images of the two people move about on the screen 20.

Image signal light IB₁ and communication signal light SB₁ are projected onto image section F₁, and image signal light IB₂ and communication signal light SB₂ are projected onto the image section F₂. As described in detail later, the information sections IU₁, IU₂ function as units of repetition of the information included in the communication signal light SB₁, SB₂. Communication signal light SB₁ conveys the same information to each information section IU₁ in image section F₁ and communication signal light SB₂ conveys the same information to each information section IU₂ in image section F₂. In other words the communication signal light carries the same message to any information section within the same image section. The image sections and information sections will be described in further detail later.

The communication signal light SB₁, SB₂ may include a request for an answer to be sent to the projector 12. In a movie, for example, the information carried by the communication signal light SB₁, SB₂ might include profiles of the actors on the screen or the characters they represent, accompanied by a question asking for audience approval or disapproval of the actor or character.

The terminal 14 comprises a telescopic optical system, a terminal receiver, a terminal processor, and a terminal transmitter, each of which will be described in detail later. Although only two terminals 14 are shown in FIG. 1, the number of terminals 14 is unlimited. In a movie, for example, each person in a large audience may have a terminal 14.

In FIG. 1, terminal 14b is pointed toward image section F₁ and receives the communication signal light SB₁ reflected from an information section IU₁ in image section F₁. Terminal 14a is pointed toward image section F₂ and receives the communication signal light SB₂ reflected from an information section IU₂ in image section F₂. The communication signal light SB₁, SB₂ received by each terminal 14b, 14a is processed in the terminal processor to retrieve the included information. The content of the information in the communication signal light SB₁ or SB₂ may be visibly displayed or audibly reproduced by an output apparatus in the terminal 14b or 14a.

In the above example of a movie, a person who points his or her terminal 14 toward image section F₁ or F₂, so that the terminal 14 receives the communication signal light SB₁ or SB₂ reflected from image section F₁ or F₂, sees a character profile and a question displayed on the display of the terminal 14. The person may then operate an input apparatus provided in the terminal 14 to answer the question and send the answer to the projector 12. The answer is transmitted from the terminal to the projector receiver 18 in an answering optical signal TS comprising infrared light, which is not perceived by the human eye.

The answering optical signal TS passes through the filter 15 and is received by the projector receiver 18 provided behind the screen 20. The filter 15 transmits only infrared light, so the light from the image on the screen 20 and the answering optical signal TS do not interfere with each other. The projector receiver 18 converts the answering optical signal TS to an electrical signal and transfers it through the cable 22 to the main projector unit 16.

In the movie example being considered, the input apparatus provided on the terminal 14 may be a pair of push buttons, and in reply to the above question, each person may push the appropriate button to indicate approval or disapproval. The input information indicating the audience's opinions is transmitted from the terminals 14 toward the projector receiver 18 as answering optical signals TS and the results are compiled in the main projector unit 16.

### Projector

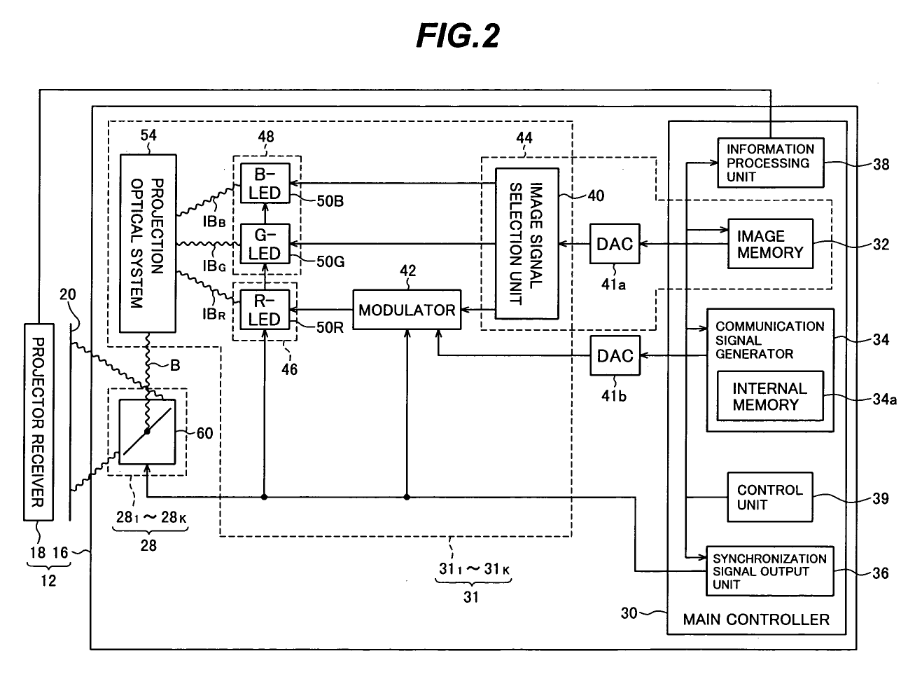

The projector 12 in the image communication system 10 will now be described with reference to FIGS. 2 to 7. First, the overall configuration of the projector 12 will be described with reference to FIG. 2.

As explained above, the 12 comprises a main projector unit 16 and a projector receiver 18.

The main projector unit 16 includes a main controller 30, which functions as the projector processing unit, k light emitting units 31₁ to 31ₖ, and k scanning units 28₁ to 28ₖ, where k is a positive integer equal to the number of the scanning lines on the screen 20.

The light emitting units 31₁ to 31ₖ have identical structures. Similarly, the scanning units 28₁ to 28ₖ have identical structures. The following description will therefore refer to one scanning unit 28 representing all of the scanning units 28₁ to 28ₖ, and its corresponding light emitting unit 31 representing all of the light emitting units 31₁ to 31ₖ.

The projector processing unit or main controller 30 comprises an image memory 32 constituting part of the image signal generator 44, a communication signal generator 34, a synchronization signal output unit 36, an information processing unit 38, and a control unit 39 for controlling the image memory 32, communication signal generator 34, synchronization signal output unit 36, and information processing unit 38. The information processing unit 38 and control unit 39 are configured as a central processing unit (CPU) executing a prestored program.

The image memory 32 stores digitized images in electrical signal form. The images may be obtained from a camera (not shown) or any other source. An electrical image signal includes electrical signals corresponding to the three primary visual colors, and thus comprises a red image signal or R-signal, a green image signal or G-signal, and a blue image signal or B-signal, which are stored separately in the image memory 32. Each of these three signals describes a monochrome image to be projected on the screen 20. The red image signal or R-signal also carries the communication signal, as described below.

The communication signal generator 34 has an internal memory 34a in which one or more communication signals to be added to the image signal are stored in digital form. The communication signal or signals are output in synchronization with the image signal and control the communication signal light SB. In the example shown in FIG. 1, two communication signals pertaining to different sections F₁, F₂ of the projected image are prestored in the internal memory 34a of the communication signal generator 34, and are output in synchronization with the image signals that control those sections of the image, so that there are in effect two optical communication signals SB₁, SB₂ bearing different messages.

The synchronization signal output unit 36 outputs synchronization signals that control the operation of the light emitting units 31 and scanning units 28.

The information processing unit 38 processes the answering optical signals TS transmitted from the terminals 14 to the projector receiver 18.

The main projector unit 16 also includes a pair of digital-to-analog converters (DACs) 41a, 41b. Digital-to-analog converter 41a converts the digital electrical image signal read from the image memory 32 to an analog electrical image signal. Digital-to-analog converter 41b converts the digital electrical information signal output from the communication signal generator 34 to an analog electrical information signal.

Each light emitting unit 31 comprises an image signal selection unit 40 functioning, with digital-to-analog converter 41a and the image memory 32, as an image signal generator 44, a modulator 42, a red light-emitting diode (R-LED) 50R functioning as a main optical image signal generator 46, green and blue light-emitting diodes (G-LED, B-LED) 50G, 50B functioning as a supplementary optical image signal generator 48, and a projection optical system 54 functioning as a light beam generator. R-LED 50R, G-LED 50G, and B-LED 50B emit light corresponding to the primary colors of visible light.

The image signal selection unit 40 receives the analog image signals from digital-to-analog converter 41a and separates them into an analog main image signal and a pair of analog supplementary image signals. The analog main image signal is the analog signal obtained from the digital R-signal; this is the main image signal in that it is the signal that will be modulated to carry the information signal. The analog supplementary image signals are the analog signals obtained from the digital G-signal and B-signal. The analog signals selected by the image signal selection unit 40 may also be referred to simply as the R-signal, G-signal, and B-signal.

The image signal selection unit 40 outputs the analog R-signal or main image signal to the modulator 42 and the analog G-signal and B-signal or supplementary image signals to the G-LED 50G and the B-LED 50B, respectively.

The modulator 42 is interposed between the image signal selection unit 40 and the R-LED 50R and receives both the analog R-signal from the image signal selection unit 40 and the analog communication signal from digital-to-analog converter 41b.

The modulator 42 modulates the signal intensity of the R-signal by the signal intensity of the communication signal in synchronization with a synchronization signal output from the synchronization signal output unit 36. The R-signal after modulation by the communication signal is referred to below as the modulated R-signal or modulated image signal. The modulated R-signal is output to the R-LED 50R, which thereby receives the sum of the communication signal and the red image signal.

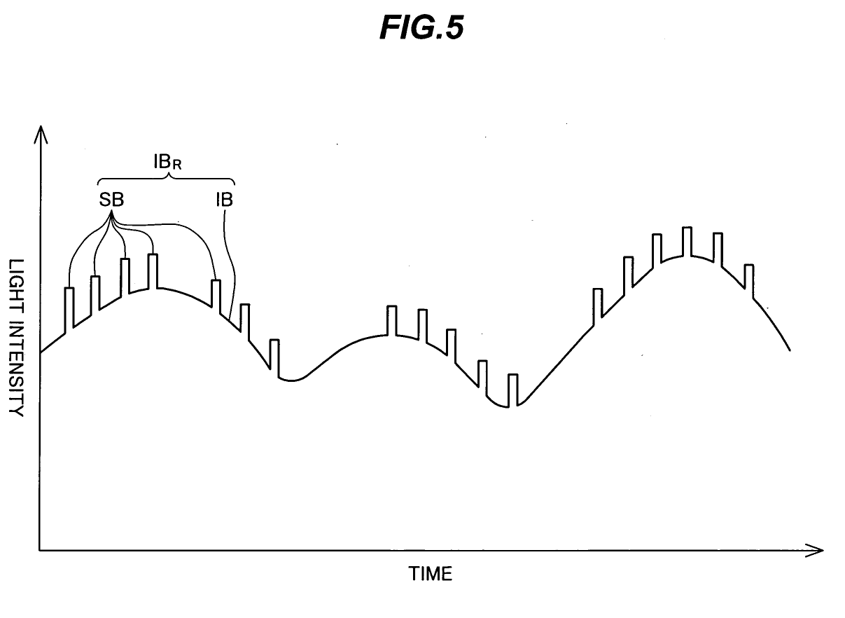

The R-LED 50R is driven by the modulated R-signal in synchronization with a synchronization signal output from the synchronization signal output unit 36. The R-LED 50R functions as the main optical image signal generator 46 in that the red optical image signal IB_{R} output by the R-LED 50R includes both image signal light IB and communication signal light SB. The R-LED 50R emits this optical image signal IB_{R} toward the projection optical system 54. The optical image signal IB_{R} (FIG. 5) will be described in detail later.

The G-LED 50G and B-LED 50B, constituting the supplementary optical image signal generator 48 generate green and blue light, respectively. Both the G-LED 50G and B-LED 50B are driven in synchronization with synchronization signals output from the synchronization signal output unit 36. The G-LED 50G converts the analog G-signal to a supplementary optical image signal IB_{G}, which is emitted toward the projection optical system 54. The B-LED 50B converts the analog B-signal to a supplementary optical image signal IB_{B}, which is also emitted toward the projection optical system 54.

The projection optical system 54 combines the main optical image signal IB_{R} received from the R-LED 50R with the supplementary optical image signals IB_{G}, IB_{B} received from the G-LED 50G and the B-LED 50B to generate a single light beam B and directs the beam onto a mirror 60 in the scanning unit 28. The projection optical system 54 will be described in detail later.

The mirror 60 in the scanning unit 28 is driven by an actuator (not shown) in synchronization with another synchronization signal output from the synchronization signal output unit 36. The mirror 60, which is fabricated using micro-electrical-mechanical-system (MEMS) technology, vibrates according to the motion of the actuator and scans the light beam B radiated from the projection optical system 54 across the screen 20. The vibration is rotational; the mirror 60 reciprocates in a circular arc.

The projector receiver 18 is a two-dimensional array of photodiodes that convert answering optical signals TS received from the terminals to electrical signals, which the projector receiver 18 sends to the information processing unit 38 in the main controller 30 through the cable 22.

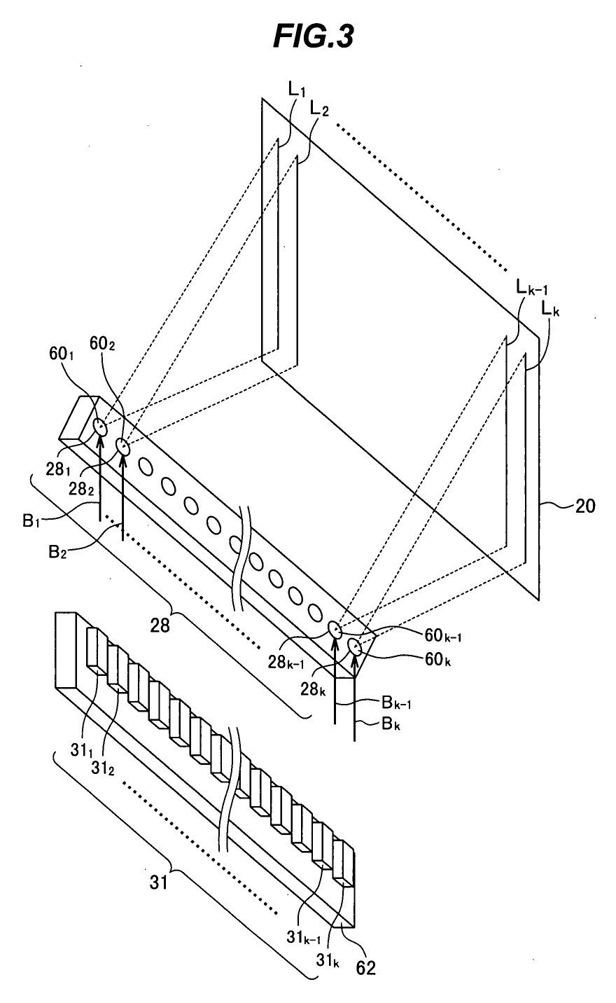

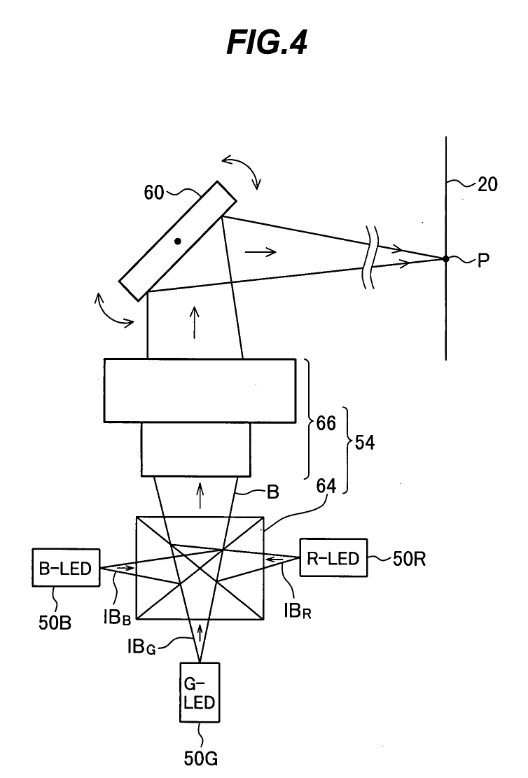

Next, the light emitting units 31 and scanning units 28 will be described with reference to FIGS. 3 and 4.

FIG. 3 shows the general arrangement of the light emitting units 31 and scanning units 28.

The k light emitting units 31₁ to 31ₖ are mounted in a row on a base 62. The scanning units 28₁ to 28ₖ are disposed in a corresponding row facing windows from which the light emitting units 31₁ to 31ₖ emit respective light beams B₁ to Bₖ. These light beams B₁ to Bₖ impinge on respective mirrors 60₁ to 60ₖ in scanning units 28₁ to 28ₖ. As the mirrors 60₁ to 60ₖ vibrate in a rotational manner in response to their synchronization signals, they reflect the light beams B₁ to Bₖ, causing the light beams B₁ to Bₖ to scan the screen 20 repeatedly in k scanning lines L₁ to Lₖ. The scanning direction is perpendicular to the direction in which the light emitting units 31₁ to 31ₖ are aligned.

Next, the projection optics of the light emitting units 31 will be described.

Referring to FIG. 4, the projection optical system 54 in each light emitting unit 31 comprises a known type of dichroic prism 64 and a projection lens 66.

The optical image signal IB_{R} emitted from the R-LED 50R and the supplementary optical image signals IB_{G}, IB_{B} emitted from the G-LED 50G and B-LED 50B are incident on the dichroic prism 64 from different directions. The dichroic prism 64 combines these three image signals IB_{R}, IB_{G}, IB_{B} into a single divergent light beam B in which the three primary colors are combined. The divergent beam B exiting the dichroic prism 64 is focused by the projection lens 66 to a scanning point on one of the scanning lines L₁ to Lₖ on the screen 20. More precisely, the light beam B exiting the projection lens 66 is a convergent beam that is reflected by the mirror 60 and propagates toward a point on the screen 20.

Next, the optical image signal IB_{R} will be described with reference to FIG. 5. The horizontal axis in FIG. 5 represents time (in arbitrary units); the vertical axis represents the light intensity (in arbitrary units) of the optical image signal IB_{R}.

The optical image signal IB_{R} is obtained by driving of the R-LED 50R by the modulated analog R-signal. As a result, as shown in FIG. 5, the optical image signal IB_{R} includes the image signal light IB as an optical component modulated according to the image signal and the communication signal light SB as an optical modulation component modulated according to the communication signal.

More specifically, the optical image signal IB_{R} has a time-domain waveform in which a high-frequency series of pulses of communication signal light SB is added onto the lower-frequency red image signal light IB. That is, the optical image signal IB_{R} is obtained by modulating the pulse sequence of the communication signal onto the red image signal light IB.

The light-emitting diode (R-LED 50R) that functions as the light source of the optical image signal IB_{R} is operable at a high speed, so the communication speed of the communication signal light SB is several tens of megabits per second.

It is known that when visible light is modulated at a frequency of 20 Hz or more the modulation or flicker is not perceived by the human visual system. Accordingly, if the optical image signal IB_{R} is modulated at the above communication speed (several tens of megabits per second), the pulse sequence of the communication signal light SB is not detected by the people viewing the projected image.

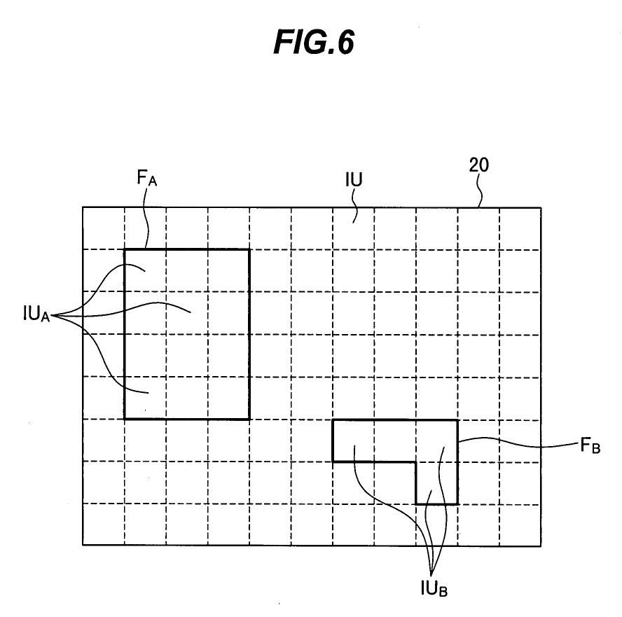

Next, the structure of the image projected on the screen 20 will be described with reference to FIG. 6.

Referring to FIG. 6, the image projected on the screen 20 includes one or more non-overlapping image sections, e.g. two image sections F_{A}, F_{B} (indicated by solid lines in the drawing). Different image information (for example, scenery and news) may be displayed in these image sections F_{A}, F_{B}.

The screen 20 is also divided into a matrix of non-overlapping information sections IU (indicated by dotted lines in the drawing) each having an identical rectangular shape. In FIG. 6, there are eight rows and eleven columns of information sections IU on the screen 20. There is a preferred relationship between the number NC of rows of information sections IU and the number NL of scanning lines per column, which will be described later (in the present example, NC and NL are both equal to eight).

Incidentally, the dotted lines that mark the boundaries of the information sections IU in FIG. 6 are shown purely for explanatory purposes; there are no such lines on the actual screen 20.

An image section may comprise one information section or two or more contiguous information sections. In FIG. 6, image section F_{A} includes twelve contiguous information sections IU_{A} and image section F_{B} includes four contiguous information sections IU_{B}.

A complete message is transmitted to each information section IU, and the same message is transmitted to all the information sections in the same image section, as noted above. That is, identical communication signal light, including the same information, is transmitted to each of the twelve information sections IU_{A} constituting image section F_{A}, and identical communication signal light is likewise transmitted to each of the four information sections IU_{B} constituting image section F_{B}. This enables the information related to a given image section to be acquired from any part of the image section.

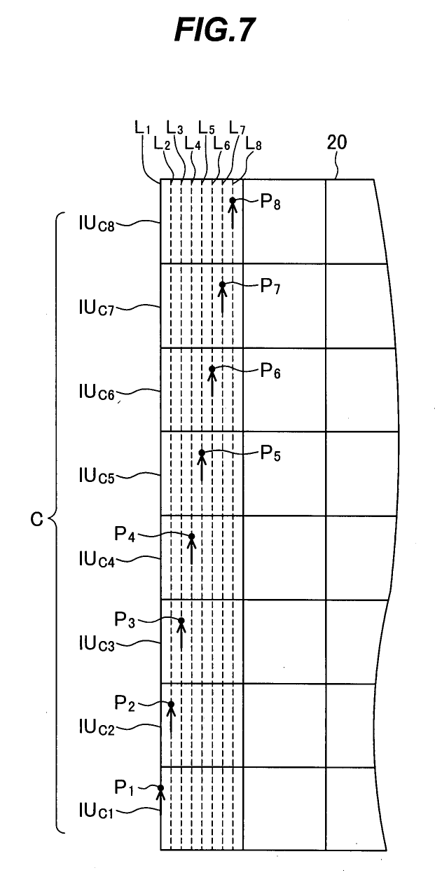

Next, the scanning of the screen 20 will be described with reference to FIG. 7. FIG. 7 shows one column C including eight information sections IU_{C1} to IU_{C8} (NC=8).

The scanning units 28 scan the light beams B emitted from the light emitting units 31 to form eight scanning lines L₁ to L₈ (NL=8) in column C. The scanning lines L₁ to L₈ extend in parallel in the vertical direction (the longitudinal direction of column C), and are equally spaced in the horizontal direction, perpendicular to the vertical direction. The number of scanning lines (eight lines) in the column is equal to the number of information sections IU_{C1} to IU_{C8} (eight sections) in the column (NL=NC). As each scanning line extends for the full longitudinal height of the column, and each information section extends for the full width of the column, this also means that the number of scanning lines per information section is equal to the number of information sections per scanning line.

The eight scanning lines L₁ to L₈ in column C are scanned simultaneously by eight beams of light B. The eight beams are focused to eight scanning points P₁ to P₈ on the screen 20, each scanning point scanning a different one of the scanning lines L₁ to L₈. Each scanning line is scanned repeatedly from bottom to top, causing the scanning points P₁ to P₈ to move at equal speeds from information section IU_{C1} toward information section IU_{C8} as indicated by the arrows in the drawing.

The synchronization signal output unit 36 controls the mirrors 60 in the scanning units 28 (see FIG. 2) so that the scanning points P₁ to P₈ are located in different information sections IU_{C1} to IU_{C8}, one scanning point being present in each information section. The scanning points P₁ to P₈ are positioned at the same height in each information section. More specifically, if a Cartesian coordinate system is established in each rectangular information section IU_{Cn} (n being an integer from 1 to 8), with the origin at the lower-left corner of the rectangle, the vertical coordinates or Y-coordinates of the scanning points Pₚ (p being an integer from 1 to 8) in the different information sections IU_{Cn} are equal to one another regardless the values of n and p.

As noted above, the scanning points Pₚ move at equal speeds. Consequently, at the instant when one scanning point Pₚ exits an information section IU_{Cn} through its upper edge, another scanning point Pₚ₋₁ enters information section IU_{Cn} from its lower edge, so that each of the information sections IU_{C1} to IU_{C8} always includes just one of the eight scanning points P₁ to P₈.

As described above, the light beams focused on the scanning points P₁ to P₈ include communication signal light SB. Therefore, information is reflected continuously from each of the information sections IU_{C1} to IU_{C8} toward the terminals 14.

Next, the amount of information transmitted from the individual information sections IU_{C1} to IU_{C8} will be described with reference to FIG. 7.

Focusing on one arbitrary information section, for example, information section IU_{C3}, let the time that the individual scanning points P₁ to P₈ take to cross the information section IU_{C3} be T (seconds) and let the data communication rate of the individual scanning points P₁ to P₈ or the modulation frequency of the communication signal light SB be V (bits/second).

The amount Q of information that one of the scanning points P₁ to P₈ can transmit from the information section IU_{C3} toward a terminal 14 is then given by the following equation (1).

Q(bits)=T×V (1)

As described above, the scanning points P₁ to P₈ are continuously scanned within the information section IU_{C3} in the order of, for example, P₃→P₄→P₅→P₆→P₇→P₈→P₁→P₂→P₃→P₄→ . . . .

Accordingly, if the information following the information carried on scanning point Pₘ is carried on the next scanning point Pₘ₊₁, the amount of information transmitted from information section IU_{C3} toward the terminals 14 can be increased to eight times the above amount Q.

In general, if the maximum amount Qₘₐₓ of information that can be transmitted from an information section IU_{C3} toward the terminals 14 is given by the following equation:

Qₘₐₓ=Q×N (2)

where N is the number of scanning lines in the information section IU_{C3}.

### Terminal

Next, the terminals 14 in the image communication system 10 will be described.

With regard to external appearance and design, since the terminal 14 will be used by a person watching the screen 20, it should have a size and a shape that allow the person to operate it easily. The size and shape of a typical remote control for a television set, for example, are appropriate for a terminal 14.

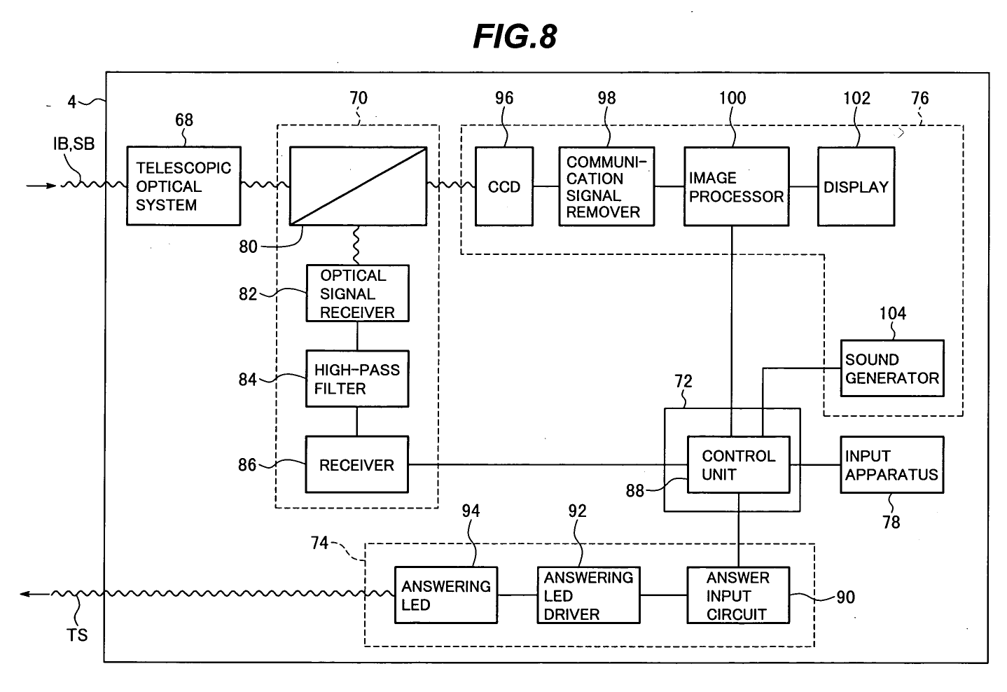

Referring to FIG. 8, the terminal 14 comprises a telescopic optical system 68, a terminal receiver 70, a terminal processor 72, a transmitter 74, an output apparatus 76, and an input apparatus 78.

The telescopic optical system 68 comprises a conventionally known lens group that enlarges the image (referred to below as an information section image) of an area equivalent to one information section IU (FIG. 6) on the screen 20. The enlarged information section image is input to an optical splitter 80 in the terminal receiver 70.

The terminal receiver 70 includes, in addition to the optical splitter 80, an optical signal receiver 82, a high-pass filter 84, and a receiver 86.

The optical splitter 80 splits the enlarged information section image received from the telescopic optical system 68 and provides identical copies of the image to both the optical signal receiver 82 and the output apparatus 76.

The optical signal receiver 82 receives the enlarged information section from the optical splitter 80 and converts its red component (the optical image signal IB_{R}) to an electrical signal. The optical signal receiver 82 comprises, for example, a wavelength selection filter and a conventional photodiode (not shown). The wavelength selection filter selects red light. The red optical image signal IB_{R} passes through the wavelength selection filter and is converted to an electrical signal by the photodiode. The blue and green optical image signals IB_{G} and IB_{B} are blocked by the filter.

The high-pass filter 84 selects and extracts the communication signal from the electric signal output by the optical signal receiver 82. That is, the high-pass filter 84 transmits the comparatively high-frequency communication signal SB while blocking the lower-frequency image signal IB (see FIG. 5). By passing through the high-pass filter 84, the electrical signal input from the optical signal receiver 82 is converted to a communication signal.

The receiver 86 receives the communication signal from the high-pass filter 84 and outputs it to the terminal processor 72.

The terminal processor 72 controls the transmitter 74, output apparatus 76, and input apparatus 78 according to the communication signal input from the receiver 86. The terminal processor 72 comprises a control unit 88 configured as a CPU. The control unit 88 reads the communication signal input from the receiver 86. If the communication signal includes a request to display information, the control unit 88 controls the output apparatus 76 to display the requested information, which is included in the communication signal, on a display 102. If the communication signal includes a request to produce audible information, the control unit 88 controls the output apparatus 76 to produce the requested information, which is included in the communication signal, through a sound generator 104.

If the communication signal includes a request for answering information, the control unit 88 controls the output apparatus 76 to display a message prompting the person holding the terminal 14 to enter answering information on the input apparatus 78. The control unit 88 receives the answering information from the input apparatus 78 and controls the transmitter 74 to convert the answering information to an optical signal. The transmitter 74 transmits the optical signal TS to the projector receiver 18.

The transmitter 74 comprises an answer input circuit 90, an answering LED driver 92, and an answering LED 94. The answer input circuit 90 receives the answering information from the input apparatus 78 via the control unit 88. The answering LED driver 92 drives the answering LED 94 according to the answering information. The answering LED 94 is, for example, an infrared LED that transmits the answering information to the projector receiver 18 as an infrared optical signal TS.

The output apparatus 76 comprises a charge coupled device (CCD) 96, a communication signal remover 98, an image processor 100, the display 102, and the sound generator 104.

The CCD 96 receives the enlarged image of the information section from the optical splitter 80 and converts it to an electrical signal, from which the communication signal remover 98 extracts the image signal. The communication signal remover 98 is a low-pass filter that passes the image signal, which has a lower frequency than the communication signal.

The image processor 100 is controlled by the control unit 88 to select the image to be displayed on the display 102. When the communication signal includes a request for display of information included in the communication signal, the image processor 100 receives the information from the control unit 88 and controls the display 102 to display the information. At other times, the image processor 100 controls the display 102 to display the image of the information section received from the communication signal remover 98. The image processor 100 may be implemented on the same CPU as the control unit 88, or on a separate CPU.

The sound generator 104 is equipped with, for example, a speaker. When the communication signal includes a request for production of audible information, the sound generator 104 produces audible output representing the content of the communication signal under the control of the control unit 88.

The input apparatus 78 comprises, for example, a set of push buttons on the terminal 14, marked with characters or symbols. The input apparatus 78 is normally disabled, but when the communication signal includes a request for an answer, the input apparatus 78 is enabled by the control unit 88 and receives human input.

The effects of the image communication system 10, projector 12, and terminals 14 in the first embodiment will now be described.

The image communication system 10 allows the projector 12 to communicate bidirectionally with a large number of terminals 14.

The image communication system 10 and projector 12 use LEDs (R-LEDs 50R) having a fast modulation speed as light sources for transmitting the communication signal light SB. The projector 12 can transmit information to each of the terminals 14 at a rate of several tens of megabits per second.

When the terminals 14 transmit answering information to the projector 12, the answering optical signal TS is generated by an answering LED 94 which also has a high modulation speed. Consequently, the communication speed from the terminals 14 to the projector 12 can be as high or nearly as high as the communication speed from the projector 12 to the terminals 14.

As shown in FIG. 5, in the image communication system 10 of the invention, the red light beams IB_{R} include both image signal light IB and communication signal light SB. Therefore, the projector 12 can project an image on the screen 20 and transmit information to the terminals 14 at the same time, and the projected image can cover the entire area of the screen 20. It is not necessary to use separate parts of the screen 20 for image display and information transmission, or to transmit images and information at separate times.

Nor is it necessary to provide separate LEDs for image display and information transmission. The number of LEDs 50R, 50G, 50B is reduced to three per beam, which is the minimum number needed to form a full-color image. The cost of the projector 12 is reduced accordingly.

Since the projector receiver 18 is always ready to receive, the terminals 14 can transmit answering information to the projector 12 even while an image is being displayed.

In the scanning system employed in the first embodiment, the number of information sections IU per scanning line on the screen 20 is equal to the number of the scanning lines per information section IU. Consequently, by appropriately adjusting the timing of the rotational oscillations of the mirrors 60, the scanning can be arranged so that each information section IU is scanned by different beams in turn, and is nearly always being scanned by a single beam. This means that the projector 12 can transmit information continuously to each terminal 14, regardless of the information section IU that the terminal 14 focuses on. As indicated by the above equation (2), this enables a large amount of information to be beamed into an information section IU, the flow of information continuing from one scanning line to the next within the information section. As a result, the projector 12 can transmit a large amount of information to the terminals 14.

In the image communication system 10 of the invention, each image section projected on the screen 20 comprises at least one complete information section, and each information section in the same image section receives the same information. Accordingly, the terminal 14 can be pointed toward any location in the image section to receive the relevant information. The terminal 14 does not have to be aligned accurately on a single information section in the image section F. If the telescopic optical system 68 enlarges parts of two or more mutually adjacent information sections IU in the image section, as long as the enlarged image includes N scanning lines, where N is the number of scanning lines per information section, the terminal 14 will receive all the information being transmitted to that image section.

Design conditions for the image communication system 10, projector 12, and terminals 14 in the first embodiment will now be described, and some possible modifications will be explained.

In the examples shown above, the projected image included two image sections F₁, F₂ (or F_{A}, F_{B}), but the number of image sections projected on the screen 20 is not limited to two. The number of image sections may be any number from one image section (e.g., the whole screen) up to the total number of information sections on the screen (when each information section constitutes a separate image section).

In the examples shown above, the screen 20 was divided into an eight-by-eleven matrix of information sections IU, but the matrix of information sections may have any number of rows and any number of columns, provided each information section includes at least one scanning line.

The image projection area need not be a flat screen. The image may be projected onto a curved screen, for example.

The image projection area may also include, for example, a diorama in which model buildings and other objects are arranged to simulate an actual landscape. In this case, the light beam or beams including the communication signal light SB may scan the diorama, and the terminals may receive communication signal light reflected from the model buildings and other objects.

The communication signal need not be modulated onto the red optical image signal IB_{R}. The green light emitted from the G-LED 50G or blue light emitted from B-LED 50B may be modulated by the communication signal instead.

Alternatively, the light of different colors may be used to transmit communication signals on multiple channels. For example, a first communication signal may be modulated onto on the red light emitted from the R-LED 50R, a second communication signal may be modulated onto on the green light emitted from the G-LED 50G, and a third communication signal may be modulated onto the blue light emitted from the G-LED 50B, providing three communication channels from the projector 12 to the terminals 14.

The scanning scheme is not limited to a one-dimensionally array of light emitting units 31₁ to 31ₖ and scanning units 28₁ to 28ₖ that scan the screen 20 with k light beams B₁ to Bₖ that move in parallel vertical scanning lines. A single light beam emitted from a single light emitting unit may be scanned two-dimensionally on the screen 20 by a scanning unit with two mirrors. If this configuration is adopted, the number of light emitting units can be decreased to one while still providing a communication speed adequate for practical use. As a result, the projector 12 can be reduced in size and cost.

In the above description of the first embodiment, the image sections F₁, F₂ were non-overlapping. The reason for this is to prevent interference between the communication signal light SB₁ and SB₂ transmitted to the respective image sections F₁ and F₂.

If appropriate measures are taken to prevent interference, however, different image sections may overlap. An exemplary measure for preventing interference is to assign different channels to the communication signal light SB in different image section by using an optical code division multiple access (OCDMA) system or a frequency division multiplexing (FDM) system.

The output apparatus 76 in the terminal 14 need not be an electronic device as in the embodiment above. The output apparatus may also be configured as an optical finder.

It is not necessary for the number NL of scanning lines per information section IU to be equal to the number NC of information sections IU per scanning line. NL may be any positive integer multiple of NC. That is, the number of scanning lines per information section may be any number NL satisfying the equation NL=NC×r, where r is any positive integer.

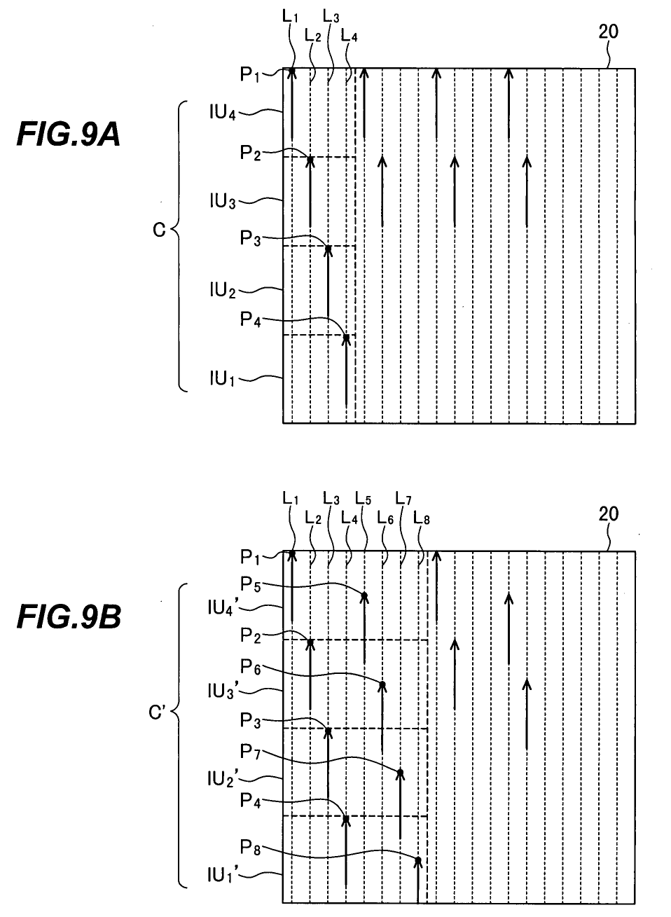

A preferred scanning method for the general case in which NL=NC×r will be described below with reference to FIGS. 9A and 9B.

In FIG. 9A, the number NC of information sections in one column C on the screen is four, and the number NL of scanning lines in one information section is equal to this number (four). This is the case in which the integer r is equal to unity (r=1). Each of the information sections IU₁ to IU₄ includes four scanning lines L₁ to L₄, and the column C includes four information sections IU₁ to IU₄.

FIG. 9A shows the instant at which adjacent scanning points Pₛ, Pₛ₊₁ (where s is an integer from 1 to 3) are located on the upper and lower boundaries of an information section IUᵤ (where u is an integer from 1 to 4). In this state (referred to below as the scanning point absent state), no scanning point is definitely present within information section IUᵤ, so a terminal 14 may experience a momentary outage of received communication signal light SB.

In FIG. 9B, the number NL of scanning lines per information section IUᵤ′ is twice the number NC of the information sections in one column C′ on the screen 20, corresponding to the case in which the integer r is equal to two (r=2). Each of the information sections IU₁′ to IU₄′ has eight scanning lines L₁ to L₈, and one column C′ includes four information sections IU₁′ to IU₄′.

The scanning timing of the scanning point P_{w} on scanning line L_{w} (where w is an integer from 1 to 4) is shifted from the timing of the scanning point P_{w+4} on scanning line L_{w+4} by approximately half the height of information section IUᵤ′. This prevents the scanning point absent state from occurring in information section IUᵤ′ and ensures that there is always at least one scanning point inside information section IUᵤ′.

In the first embodiment, each light emitting unit 31 included three LEDs emitting light of respective primary colors (red, green, and blue), but the number of LEDs and number of colors are not limited to three. For example, a white LED may be used in addition to the red, green, and blue LEDs. Alternatively, four or more primary colors may be used.

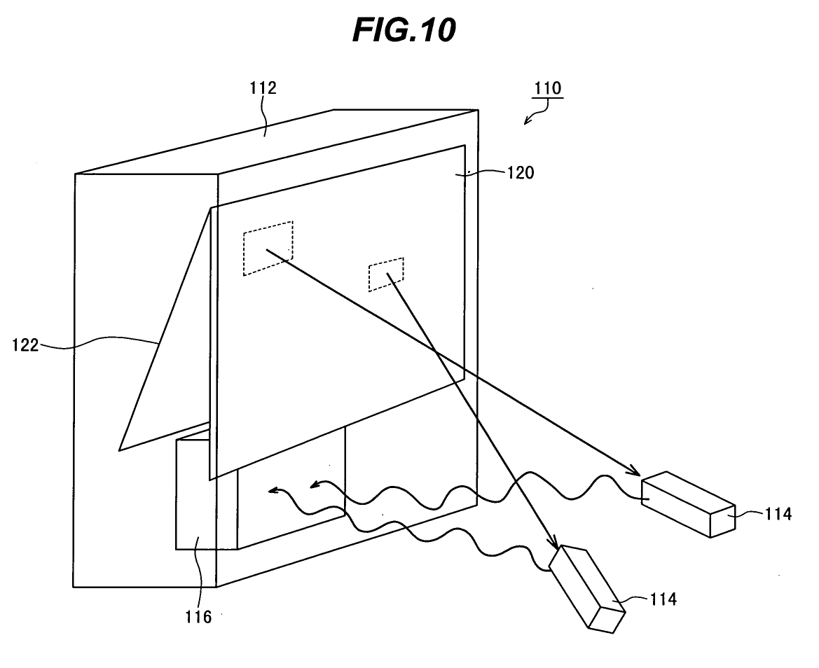

FIG. 10 illustrates a modification of the image communication system 10 in which a projector 112 of the rear projection type is used and the terminals 114 transmit radio signals.

A main projector unit 116 housed inside the projector 112 radiates a light beam, which is reflected by a reflecting mirror 122 and projected on the screen 120 from the rear. The main projector unit 116 has a receiver (not shown) for receiving radio signals including answering information from the terminals 114. The communication speed of these radio signals is not necessarily as high as the communication speed of the optical signal used to transmit information from the projector 112 to the terminals 114, but is still high enough for practical use.

The use of a large outdoor site as an image projection area is also within the contemplation of the present invention. The projector in this case could be disposed above ground, possibly in a satellite orbiting the earth. The image sections might correspond to actual buildings, vehicles, or other target objects within the image projection area. The terminals, which could be located on or near the ground, would receive communication signal light SB reflected from the objects on the ground. Radio signals may also be used for communication from the terminals to the projector in this case.

### Second Embodiment

The second embodiment differs from the first embodiment by using infrared communication signal light.

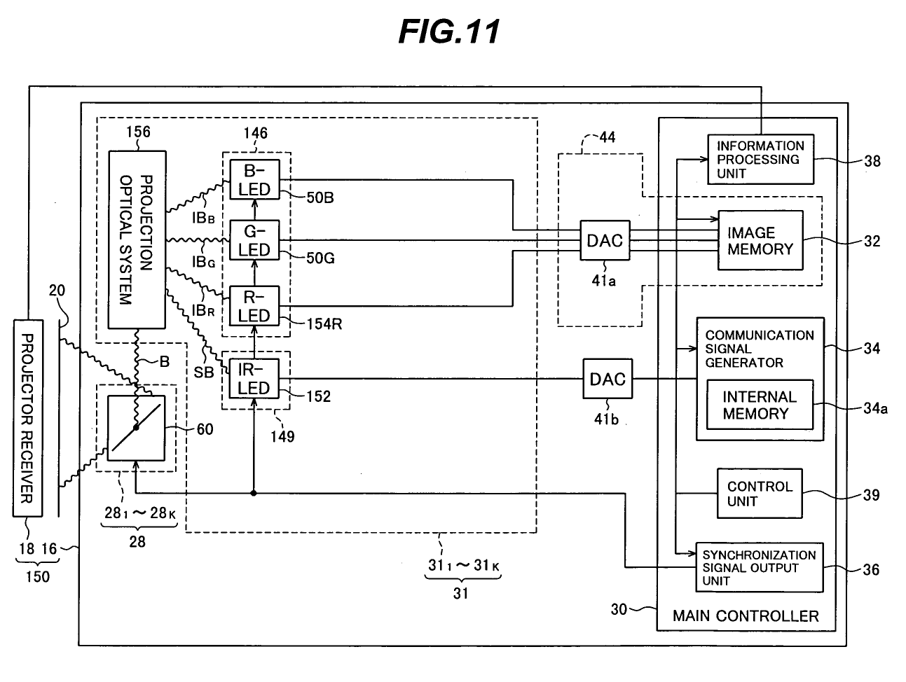

Referring to FIG. 11, the projector 150 in the second embodiment has substantially the same configuration as in the first embodiment, except that each light emitting unit 31 in its main projector unit 16 is equipped with an additional infrared LED (IR-LED) 152, and does not have the image signal selection unit and modulator that were used in the first embodiment. The following description will focus on the differences between the projector 150 in the second embodiment and the projector 12 in the first embodiment.

Digital-to-analog converter 41a outputs separate red, green, and blue image signals from the image memory 32 directly to the R-LED 154R, G-LED 50G, and B-LED 50B, which function as the optical image signal generator 146.

The IR-LED 152 functions as an optical communication signal generator 149. The IR-LED 152 is connected through digital-to-analog converter 41b to the communication signal generator 34 in the main controller 30. The IR-LED 152 is driven by one or more communication signals read from the internal memory 34a in the communication signal generator 34 in synchronization with a synchronization signal output from the synchronization signal output unit 36, and emits infrared light modulated by the communication signals. The electrical communication signals are thereby converted to communication signal light, which is emitted as optical communication signal SB toward the projection optical system 156.

The infrared light emitted by the IR-LED 152 has a wavelength external to the visible wavelength band of the optical image signals IB_{R}, IB_{G}, and IB_{B}. The wavelength emitted by the IR-LED 152 also differs from the wavelength of the infrared light transmitted by the terminals 14 (FIG. 1) in their answering optical signals TS.

The R-LED 154R generates the same red light as did the R-LED 50R in the first embodiment, except that the red light is not modulated by the communication signal and thus does not include communication signal light. The R-LED 154R, like the G-LED 50G and B-LED SOB, is connected directly to the image memory 32 through the digital-to-analog converter 41a.

Since the R-LED 154R is driven only by the analog R-signal output by digital-to-analog converter 41a, the optical image signal IB_{R} includes only image signal light. Similarly, as in the first embodiment, the G-LED 50G and B-LED SOB, which are driven by the analog G-signal and B-signal output from the digital-to-analog converter 41a, emit optical image signals IB_{G}, IB_{B} that include only image signal light. All three optical image signals IB_{R}, IB_{G}, IB_{B} are emitted toward the projection optical system 156.

The projection optical system 156, which functions as the light beam generator, combines the visible optical image signals IB_{R}, IB_{G}, IB_{B} and the infrared optical communication signal SB to form a single light beam, which is directed toward the mirror 60 in the scanning unit 28.

Each scanning unit 28 thus projects a light beam B including image signal light and communication signal light onto the screen 20, as in the first embodiment (FIG. 1). The filter 15 disposed between the projector receiver 18 and the screen 20 transmits the infrared answering optical signals TS from the terminals 14 but blocks the infrared signal light SB, which is reflected from the screen 20 toward the terminals 14.

Alternatively, the terminals 14 may transmit radio signals to the projector 150.

In the above description of the second embodiment a single wavelength of infrared light is used for the optical communication signal SB, but by providing multiple infrared LEDs that emit infrared light of different wavelengths, it is possible to provide an arbitrary number of communication channels from the projector 150 to the terminals. The number of communication wavelength channels is accordingly not limited to the number of visible wavelengths employed; even if there are only three optical image signals IB_{R}, IB_{G}, IB_{B} (three primary colors), there may be any number of infrared communication channels.

Those skilled in the art will recognize that further variations of both of the embodiments above are possible within the scope of the invention, which is defined in the appended claims.

What is claimed is:

1. A projector for projecting an image on an image projection area by linear scanning, the projector comprising:
an image signal generator for generating an image signal;
a communication signal generator for generating a communication signal;
at least one light emitting unit for generating a light beam including both image signal light modulated by the image signal and communication signal light modulated by the communication signal;
at least one scanning unit for scanning the light beam repeatedly across the image projection area to form a visible image; and
a projector receiver for receiving answering information responding to the communication signal, the answering signal being transmitted by a terminal that has received the communication signal light from the image projection area.

2. The projector of claim 1, wherein the light emitting unit comprises:
a modulator for modulating the image signal according to the communication signal to generate a modulated image signal;
an optical image signal generator driven by the modulated image signal, for generating an optical image signal including the image signal light and the communication signal light; and
a light beam generator for converting the optical image signal into said light beam.

3. The projector of claim 2, wherein:
the image signal generator includes an image signal selection unit that generates a supplementary image signal in addition to the image signal;
the light emitting unit further comprises a supplementary optical image signal generator driven by the supplementary image signal, for converting the supplementary image signal to a supplementary optical image signal; and
the light beam generator generates the light beam by combining the optical image signal with the supplementary optical image signal.

4. The projector of claim 3, wherein the optical signal generator and the supplementary optical signal generator each include at least one light-emitting diode operable to emit visible light, the total number of light-emitting diodes in the optical signal generator and the supplementary optical signal generator being at least three, the at least three light-emitting diodes including light-emitting diodes operable to emit light of wavelengths corresponding to at least three primary colors of visible light.

5. The projector of claim 1, wherein the light emitting unit comprises:
an optical image signal generator for converting the image signal to the image signal light and outputting the image signal light;
an optical communication signal generator for converting the communication signal to communication signal light of a wavelength external to a wavelength band of the optical image signal and outputting the communication signal light; and
a light beam generator for generating said light beam by combining the optical image signal and the optical communication signal.

6. The projector of claim 5, wherein the communication signal light is infrared light.

7. The projector of claim 6, wherein the optical communication signal generator comprises a light-emitting diode operable to emit infrared light.

8. The projector of claim 1, wherein the projector receiver further comprises a projector processor operable to carry out processing responsive to the answering information transmitted by the terminal.

9. The projector of claim 1, wherein the projector receiver receives the answering information from the terminal by radio communication.

10. The projector of claim 1, wherein the projector receiver receives the answering information from the terminal by optical communication, the receiver being disposed behind the image projection area.

11. The projector of claim 1, wherein the image projection area is a screen.

12. The projector of claim 1, wherein the image projection area is scanned in a plurality of mutually parallel scanning lines extending in a scanning line direction, the image projection area being divided into rectangular information sections having equal lengths and equal widths, the equal lengths dividing the image projection area into i equal parts in the scanning line direction, where i is an integer greater than unity, each of the equal widths accommodating at least i scanning lines, each information section receiving information constituting a complete message transmitted by the communication signal light.

13. The projector of claim 12, wherein the image projection area includes j image sections of variable size, each image section including at least one of the information sections, the image sections being movable on the image projection area, all of the information sections constituting one image section receiving identical information in the communication signal light.

14. The projector of claim 12, wherein the number of light emitting units and the number of scanning units is greater than one, the light emitting units generating respective light beams including respective image signal light and communication signal light, the scanning units scanning the light beams so that each scanning line in the image projection area is scanned by a different one of the light beams.

15. The projector of claim 14, wherein the scanning units scan the light beams so that each one of the information sections is scanned by one light beam at a time.

16. A terminal for receiving the communication signal light transmitted from the projector of claim 12, comprising:
an optical system for generating an enlarged image of one information section among said information sections;
a terminal receiver for receiving the communication signal light projected onto said one information section from the optical system;
a terminal processor for processing information included in the received communication signal light; and
a transmitter for transmitting the answering information to the projector in response to a request included in the information processed by the terminal processor.

17. The terminal of claim 15, further comprising a display for displaying information responsive to a request for information display if the information processed by the terminal processor includes said request for information display.

18. The terminal of claim 15, further comprising a sound generator for producing audible information responsive to a request for audible information production if the information processed by the terminal processor includes said request for audible information production.

19. An image communication system including the projector of claim 1 and at least one said terminal, the terminal comprising:
an optical system for generating an enlarged image of a part of the image projection area receiving the communication signal light;
a terminal receiver for receiving the communication signal light included in the enlarged image from the optical system;
a terminal processor for processing information included in the received communication signal light; and
a transmitter for transmitting the answering information to the projector in response to a request included in the information processed by the terminal processor.
